(19) United States
(12) Patent Application Publication
(10) Pub. No.: US 2019/0126438 A1
(43) Pub. Date: May 2, 2019

(54) Clamping Device System

(71) Applicant: Everite Machine Products Co., Pennsauken, NJ (US)

(72) Inventors: Brian Reid, Hammonton, NJ (US); Stephen Kiehl, Columbia, PA (US)

(21) Appl. No.: 15/794,246

(22) Filed: Oct. 26, 2017

(51) Int. Cl. B25B 5/06; B25B 5/02

(52) U.S. Cl. CPC B25B 5/061; B25B 5/02

(57) ABSTRACT

Disclosed is a clamping device system comprising a block, a first clamp, a first piston, a second piston, a second clamp, a third piston, a fourth piston, a control valve, a first pressure regulator, a second pressure regulator, and, a third pressure regulator. The block comprises a base and a work support plate. The first clamp comprises a first end, a first clamp body and a second end. The second clamp comprises a third end, a second clamp body and a fourth end. The first piston comprises a first piston-first clamp end and a first piston-block end. The first piston-first clamp end is attached to the first end. The first piston-block end is attached to the base. The second piston, third piston and fourth piston are configured similar to the first piston.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to pneumatic and hydraulic clamping device systems. Currently, clamping mechanisms apply equal force to the tubing on both the in-feed and out-feed side of the cutoff wheel. The out-feed side of the tubing, after wheel pass-through or cutoff, may not have the cross section and longitudinal length to resist the clamping forces which may result in deformation or damage to the tube. The present invention solves these deficiencies.

The clamping device system utilizes two clamps, one on the work in-feed side of the electrolytic cutoff wheel and one on the cutoff or out-feed side of the electrolytic cutoff wheel, to hold the tubing in place for the cut-to-length application. The clamping device system has the unique ability to independently control the clamping force to the tubing on either side of the cutoff wheel. The clamping force is controlled by independently controlling the pneumatic or hydraulic pressure to the cylinders through the use of precision electronic air pressure regulators controlled by a programmable logic controller from set point data entered into a human machine interface. The capability to independently control the pneumatic or hydraulic pressure and thus the clamping force to the in-feed and the out-feed side of the electrolytic cutoff wheel permits lower clamping force to the out-feed side preventing damage or destruction of the cut-to-length tube.

### BRIEF SUMMARY OF THE INVENTION

An object of the present invention is a clamping device system comprising a block; a first clamp; a first piston; a second piston; a second clamp; a third piston; a fourth piston; a control valve; a first pressure regulator; a second pressure regulator; and, a third pressure regulator. The block comprises a base and a work support plate. The first clamp comprises a first end, a first clamp body and a second end. The first piston comprises a first piston-first clamp end and a first piston-block end. The first piston-first clamp end is attached to the first end. The first piston-block end is attached to the base. The second piston comprises a second piston-first clamp end and a second piston-block end. The second piston-first clamp end is attached to the second end. The second piston-block end is attached to the base. The second clamp comprises a third end, a second clamp body and a fourth end. The third piston comprises a third piston-second clamp end and a third piston-block end. The third piston-second clamp end is attached to the third end. The third piston-block end is attached to the base. The fourth piston comprises a fourth piston-second clamp end and a fourth piston-block end. The fourth piston-second clamp end is attached to the fourth end. And, the fourth piston-block end is attached to the base.

In another embodiment of the present invention, the work support plate is removably attached.

In yet another embodiment of the present invention, the work support plate is adjustable.

In another embodiment of the present invention, the clamping device system further comprises a means for providing fluid pressure.

In yet another embodiment of the present invention, the means for providing fluid pressure is a pneumatic fluid.

In another embodiment of the present invention, the pneumatic fluid is pressurized air.

In yet another embodiment of the present invention, the means for providing fluid pressure is a hydraulic fluid.

In another embodiment of the present invention, the hydraulic fluid pressure is oil.

In yet another embodiment of the present invention, the first piston-block end is recessed into the base.

In another embodiment of the present invention, the second piston-block end is recessed into the base.

In yet another embodiment of the present invention, the third piston-block end is recessed into the base.

In another embodiment of the present invention, the fourth piston-block end is recessed into the base.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a perspective view of an embodiment of the present invention.

FIG. 2 is a perspective view of an embodiment of the present invention.

FIG. 3 is schematic illustrating the flow of means for providing fluid pressure of an embodiment of the present invention.

FIG. 4 is a perspective view of an embodiment of the present invention.

### DETAILED DESCRIPTION OF THE INVENTION

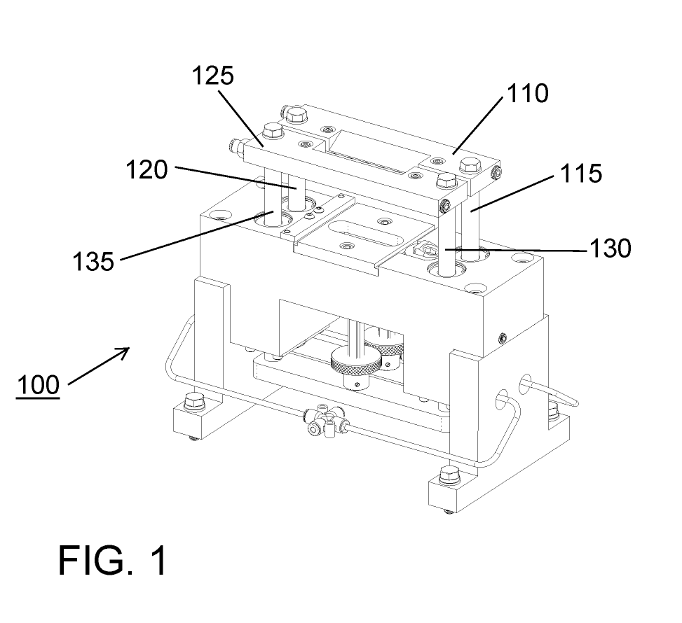

Various embodiments of the present invention are illustrated in the figures. With reference to FIGS. 1, 2 and 3, embodiments of a clamping device system 100 comprising a block 105; a first clamp 110; a first piston 115; a second piston 120; a second clamp 125; a third piston 130; a fourth piston 135; a control valve 140; a first pressure regulator 145; a second pressure regulator 150; and, a third pressure regulator 155.

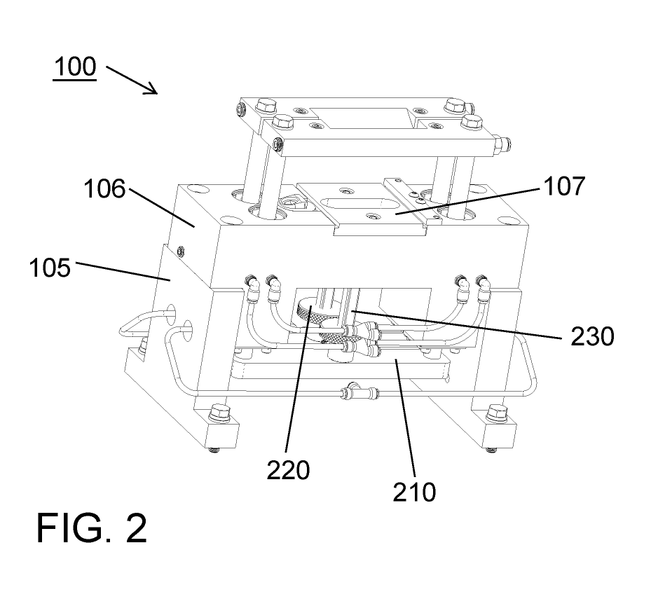

The block 105 comprises a base 106 and a work support plate 107. In FIGS. 1 and 2, the base 106 is illustrated as being in several parts; however, the base 106 may be manufactured as solid piece.

The first clamp 110 comprises a first end 111, a first clamp body 112 and a second end 113. The first piston 115 comprises a first piston-first clamp end 116 and a first piston-block end 117. The first piston-first clamp end 116 is attached to the first end 111. The first piston-block end 117 is attached to the base 106. The second piston 120 comprises a second piston-first clamp end 121 and a second piston-block end 122. The second piston-first clamp end 121 is attached to the second end 113. The second piston-block end 122 is attached to the base 106.

The second clamp 125 comprises a third end 126, a second clamp body 127 and a fourth end 128. The third piston 130 comprises a third piston-second clamp end 131 and a third piston-block end 132. The third piston-second clamp end 131 is attached to the third end 126. The third piston-block end 132 is attached to the base 106. The fourth piston 135 comprises a fourth piston-second clamp end 136 and a fourth piston-block end 137. The fourth piston-second clamp end 136 is attached to the fourth end 128. The fourth piston-block end 137 is attached to the base 106. Within the scope of the present invention, alternative embodiments include clamps that may have more than two pistons.

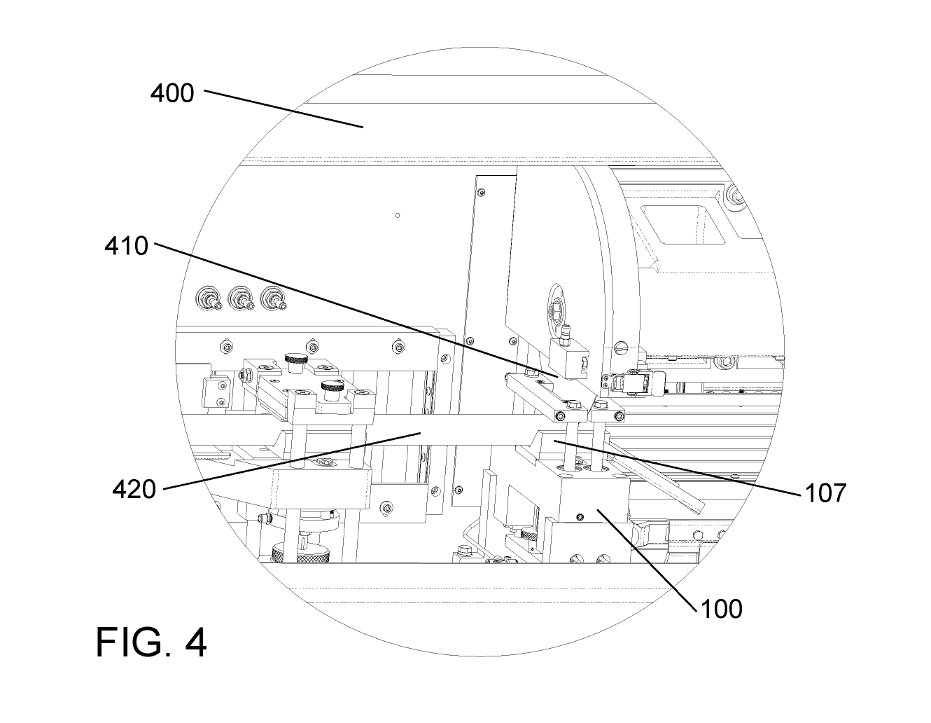

Embodiments of the clamping device system 100 are configured wherein the first clamp 110 and second clamp 125 are configured to have a space between the first clamp 110 and the second clamp 125 where the cutoff wheel 410 is between the first clamp 110 and second clamp 125, an example of which is shown in FIG. 4. Various embodiments of the present invention may be designed to have different sized spaces between the first clamp 110 and second clamp 125 to allow the use of different size cutoff wheels 410.

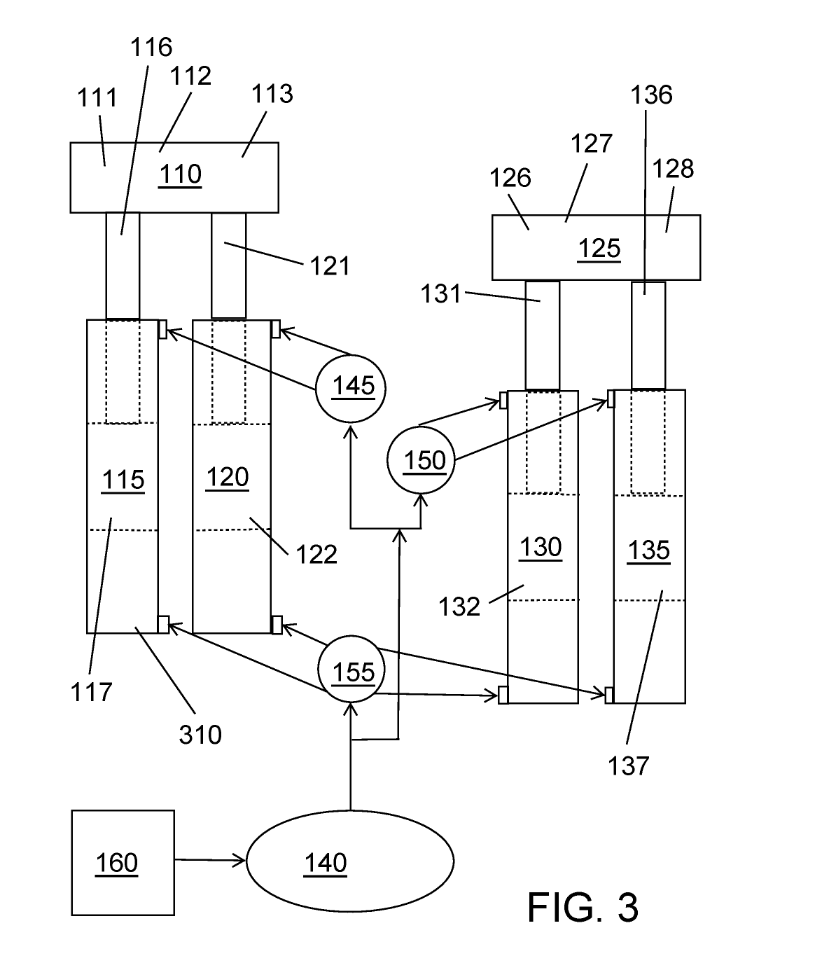

FIG. 3 illustrates the flow of the means for providing fluid pressure 160 of an embodiment of the present invention. The fluid flows through the control valve 140, which facilitates the actuation of the first clamp 110 and the second clamp 125. The fluid then flows from the control valve 140 to the first pressure regulator 145, the second pressure regulator 150, and the third pressure regulator 155. The control valve may be any valve, such as a solenoid valve or other electrochemically operated valve, that controls the flow of the fluid.

The fluid flows from the first pressure regulator 145 to the piston cylinders 310 holding the first piston 115 and the second piston 120. The first pressure regulator 145 regulates the amount of force that the first clamp 110 applies to the workpiece 420 (FIG. 4). The fluid also flows from the second pressure regulator 150 to the piston cylinders 310 holding the third piston 130 and the fourth piston 135. The second pressure regulator 150 regulates the amount of force that the second clamp 125 applies to the workpiece 420 (FIG. 4). The amount of force that the first clamp 110 applies to the workpiece 420 may be more, the same, or less than the amount of force that the second clamp 125 applies to the workpiece 420. For clarity, in FIG. 3, only the piston cylinder 310 for the first piston 115 is labeled. The piston cylinders 310 may be attached to the base 106; alternatively, the base 106 may be machined to form piston cylinders 310 that contain the pistons 115, 120, 130, 135.

The fluid may flow to the third pressure regulator 155 to the piston cylinders 310, thereby raising the clamps 110, 125 away from the workpiece 420. Although FIG. 3 illustrates just a single pressure regulator 155 to control the movement of the clamps 110, 125 simultaneously away from the workpiece 420, the present invention may include another pressure regulator to raise the clamps 110, 125 independently.

The fluid is any substance that flows, including liquids and gases. Examples of suitable liquids include, but are not limited to, oil and water. Examples of oils include, but are not limited to, mineral, rapeseed (canola), glycol, esters, organophosphate ester, polyalphaolefin, propylene glycol and silicone oils. Examples of gases include, but are not limited to, air, compressed air, pressurized air and inert gases. In an embodiment of the present invention, the means for providing fluid pressure is a hydraulic fluid. In another embodiment of the present invention, the hydraulic fluid is oil. In an embodiment of the present invention, the means for providing fluid pressure is a pneumatic fluid. In another embodiment of the present invention, the pneumatic fluid is pressurized air.

FIG. 2, illustrates another embodiment of the present invention where the work support plate 107 is removably attached. The work support plate 107 may become worn and eroded by movement of workpieces 420 and contact with cutoff wheels 410. The shape and profile of the work support plate 107 may differ to accommodate different sized and shaped workpieces 420. For example, in FIGS. 1 and 2, embodiments of the work support plate 107 is flat; whereas, the embodiment of the work support plate 107 illustrated in FIG. 4 is U-shaped or concave to support a workpiece 420 that is round or tubular. FIG. 4 also illustrates the application of the clamping device system in an electrochemical automatic tube cutoff machine 400.

In another embodiment of the present invention, the work support plate 107 is adjustable. The work support plate 107 may be adjusted to move towards or away from the clamps 110, 125 to accommodate the size and shape of the workpiece 420. An example of the adjustment mechanism is illustrated, wherein the adjustment mechanism comprises an adjustment plate 210, an adjustment knob 220, and an adjustment rod 230. The adjustment rod 230 may be removably attached to the work support plate 107. The adjustment knob 220 may be rotated clockwise to actuate the adjustment rod down, thereby lowering the work support plate 107. Conversely, the adjustment knob 220 may be rotated counter-clockwise to actuate the adjustment rod up, thereby raising the work support plate 107.

In an embodiment of the present invention, the first piston-block end 117 is recessed into the base 106. In another embodiment of the present invention, the second piston-block end 122 is recessed into the base 106. In another embodiment of the present invention, the third piston-block end 132 is recessed into the base 106. In another embodiment of the present invention, the fourth piston-block end 137 is recessed into the base 106.

The clamping device system may further comprise cooling channels that utilize a coolant, such as a dielectric fluid, to reduce the heat generated by the actuation of the clamps 110, 125.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A clamping device system comprising:
a block; wherein the block comprises a base and a work support plate;
a first clamp; wherein the first clamp comprises a first end, a first clamp body and a second end;
a first piston; wherein the first piston comprises a first piston-first clamp end and a first piston-block end; wherein the first piston-first clamp end is attached to the first end; and, wherein the first piston-block end is attached to the base;
a second piston; wherein the second piston comprises a second piston-first clamp end and a second piston-block end; wherein the second piston-first clamp end is attached to the second end; and, wherein the second piston-block end is attached to the base;
a second clamp; wherein the second clamp comprises a third end, a second clamp body and a fourth end;
a third piston; wherein the third piston comprises a third piston-second clamp end and a third piston-block end; wherein the third piston-second clamp end is attached to the third end; and, wherein the third piston-block end is attached to the base;
a fourth piston; wherein the fourth piston comprises a fourth piston-second clamp end and a fourth piston-block end; wherein the fourth piston-second clamp end is attached to the fourth end; and, wherein the fourth piston-block end is attached to the base;
a control valve;
a first pressure regulator;
a second pressure regulator; and,
a third pressure regulator.

2. The clamping device system of claim 1, wherein the work support plate is removably attached.

3. The clamping device system of claim 2, wherein the work support plate is adjustable.

4. The clamping device system of claim 1, wherein the clamping device system further comprises a means for providing fluid pressure.

5. The clamping device system of claim 4, wherein the means for providing fluid pressure is a pneumatic fluid.

6. The clamping device system of claim 5, wherein the pneumatic fluid is pressurized air.

7. The clamping device system of claim 4, wherein the means for providing fluid pressure is a hydraulic fluid.

8. The clamping device system of claim 7, wherein the hydraulic fluid pressure is oil.

9. The clamping device system of claim 1, wherein the first piston-block end is recessed into the base.

10. The clamping device system of claim 1, wherein the second piston-block end is recessed into the base.

11. The clamping device system of claim 1, wherein the third piston-block end is recessed into the base.

12. The clamping device system of claim 1, wherein the fourth piston-block end is recessed into the base.
